(19) United States
(12) Patent Application Publication
(10) Pub. No.: US 2015/0369208 A1
(43) Pub. Date: Dec. 24, 2015

(54) VOLUMETRIC HYDRAULIC MACHINE FOR PRESSURIZED WATER SUPPLY

(71) Applicants: Alberto BRIGAGLIA, (US); Franco PINNA, (US)

(72) Inventor: Franco PINNA, OLBIA (IT)

(21) Appl. No.: 14/764,810

(22) PCT Filed: Jan. 27, 2014
(86) PCT No.: PCT/EP2014/051497

§ 371 Date: Jul. 30, 2015

(30) Foreign Application Priority Data
Jan. 31, 2013 (IT) MI 2013A 000135

(51) Int. Cl. F03C 1/24; F03C 1/26; F01B 1/06; F03C 1/04

(52) U.S. Cl. CPC F03C 1/2454; F03C 1/04; F03C 1/26; F01B 1/06

(57) ABSTRACT

A volumetric hydraulic machine for water supply in pressure comprising a rotating slide valve integral with a crankshaft which rotates around an axis, said rotating slide valve is rotatably mounted on a distribution box that comprises a plurality of cavities respectively connected to a plurality of pipes of which an outlet pipe connected with the output in the water supply, the other remaining pipes of said plurality of pipes each respectively connected with only one of a plurality of chambers of a monoblock which integrally mounts said distribution box, said monoblock comprising a central chamber and at least a pair of further chambers, said crankshaft engaging at least a pair of connecting rods mounting pistons.

The present invention relates to a volumetric hydraulic machine for water supply in pressure.

### BACKGROUND OF THE INVENTION

Hydroelectric generators on the market exploit the pressure force of the water pipes to cause the turbines to rotate and generate electric energy. In order for the hydroelectric turbine generator to efficiently generate electric current, there is a need on the one hand to increase the speed of the water flow on the turbine blades or propellers, and on the other, to make the geometry of the turbine blades or propellers as effective as possible.

The pipes of the aqueduct supplies have water flow pressures which change significantly over time due to weather factors and use by the population or by industries.

Patent IT2011TV0045A1 describes a volumetric paddle turbine capable of exploiting the excess pressure of the aqueduct supplies to generate electric energy.

Said turbine is disadvantageously only applied to aqueduct supplies with a high pressure and flow rate. Furthermore, said paddles of said turbine are disadvantageously subject to wear caused by the minerals in the water.

Said volumetric turbine becomes less effective over time thus disadvantageously being fragile, given that said paddles are pushed by respective compression springs against an inner wall of a fluid containment cylinder to increase the pressure.

Said turbine is not capable of effectively regulating the excess water flow, given that a sudden strong increase of the water inlet risks breaking the turbine mechanism.

GB-2178488A describes a hydraulic machine exploiting the kinetic energy of water flowing through aqueduct water network, wherein said hydraulic machine comprises a pair of pistons which are intermittently interrupting the water flow. It is disadvantageous because said hydraulic machine interrupts the water flow of the aqueduct water network and the pistons are in risk of breaking.

### BRIEF SUMMARY OF THE INVENTION

The object of the present invention is to make a high-efficiency volumetric hydraulic machine which exploits the excess kinetic energy of the aqueduct supplies in a wide range of pressure and flow rate values without interrupting water supply.

It is a further object of the present invention to make a volumetric hydraulic machine that is solid and long-lasting over time, thus also resisting sudden large changes of the water flow in the supply.

In accordance with the invention, these objects are achieved with a volumetric hydraulic machine for water supply in pressure according to claim 1.

### BRIEF DESCRIPTION OF THE SEVERAL VIEWS OF THE DRAWINGS

These and other features of the present invention will become increasingly apparent from the following detailed description of one of its non-limiting practical embodiment examples disclosed in the accompanying drawings, in which:

FIG. 1 shows a perspective view of volumetric hydraulic machine;

FIG. 2 shows a side view of a practical embodiment of the volumetric hydraulic machine coupled with an existing device for generating electric current;

FIG. 3 shows a sectional axial view of FIG. 2;

FIG. 4 shows a sectional axial view of a cover;

FIG. 5 shows a sectional axial view of a rotating slide valve;

FIG. 6 shows a sectional axial view of a distribution box;

FIG. 7 shows a front view of the cover;

FIG. 8 shows a front view of the rotating slide valve;

FIG. 9 shows a front view of the distribution box;

FIG. 10 shows a sectional view of the cover according to the line X-X in FIG. 4;

FIG. 11 shows a sectional view of the rotating slide valve according to the line XI-XI in FIG. 5;

FIG. 12 shows a sectional view of the distribution box according to the line XII-XII in FIG. 6;

FIG. 13 shows a front plan view of a rotating slide valve in a first operating step;

FIG. 14 shows a sectional view according to the line XIV-XIV in FIG. 13;

FIG. 15 shows a sectional view according to the line XV-XV in FIG. 14, where the section is depicted by the oblique broken line;

FIG. 16 shows a front plan view of a monoblock according to the present invention, in the first operating step;

FIG. 17 shows a front plan view of the rotating slide valve in a second operating step;

FIG. 18 shows a sectional view according to the line XVIII-XVIII in FIG. 17;

FIG. 19 shows a sectional view according to the line XIX-XIX in FIG. 18, where the section is depicted by the oblique broken line;

FIG. 20 shows a front plan view of the monoblock according to the present invention, in the second operating step;

FIG. 21 shows a front plan view of the rotating slide valve in a third operating step;

FIG. 22 shows a sectional view according to the line XXII-XXII in FIG. 21;

FIG. 23 shows a sectional view according to the line XXIII-XXIII in FIG. 22, where the section is depicted by the oblique broken line;

FIG. 24 shows a front plan view of the monoblock according to the present invention, in the third operating step;

FIG. 25 shows a front plan view of the rotating slide valve in a fourth operating step;

FIG. 26 shows a sectional view according to the line XXVI-XXVI in FIG. 25;

FIG. 27 shows a sectional view according to the line XXVII-XXVII in FIG. 26, where the section is depicted by the oblique broken line;

FIG. 28 shows a front plan view of the monoblock according to the present invention, in the fourth operating step;

FIG. 29 shows a front plan view of the rotating slide valve in a fifth operating step;

FIG. 30 shows a sectional view according to the line XXX-XXX in FIG. 29;

FIG. 31 shows a sectional view according to the line XXXI-XXXI in FIG. 30, where the section is depicted by the oblique broken line;

FIG. 32 shows a front plan view of the monoblock according to the present invention, in the fifth operating step;

FIG. 33 shows a front plan view of the rotating slide valve in a sixth operating step;

FIG. 34 shows a sectional view according to the line XXXIV-XXXIV in FIG. 33;

FIG. 35 shows a sectional view according to the line XXXV-XXXV in FIG. 34, where the section is depicted by the oblique broken line;

FIG. 36 shows a front plan view of the monoblock according to the present invention, in the sixth operating step.

### DETAILED DESCRIPTION OF THE INVENTION

With reference to the above-listed figures, a hydraulic machine 1 for water supply in pressure can be noted comprising a cover 2 of dome-shape which closes on a cylindrical distribution box 3.

Said distribution box 3 is mounted in turn on a monoblock 4 comprising a central cylindrical body 40 and two arms: a first arm 41 and a second arm 42 arranged at 120° between them.

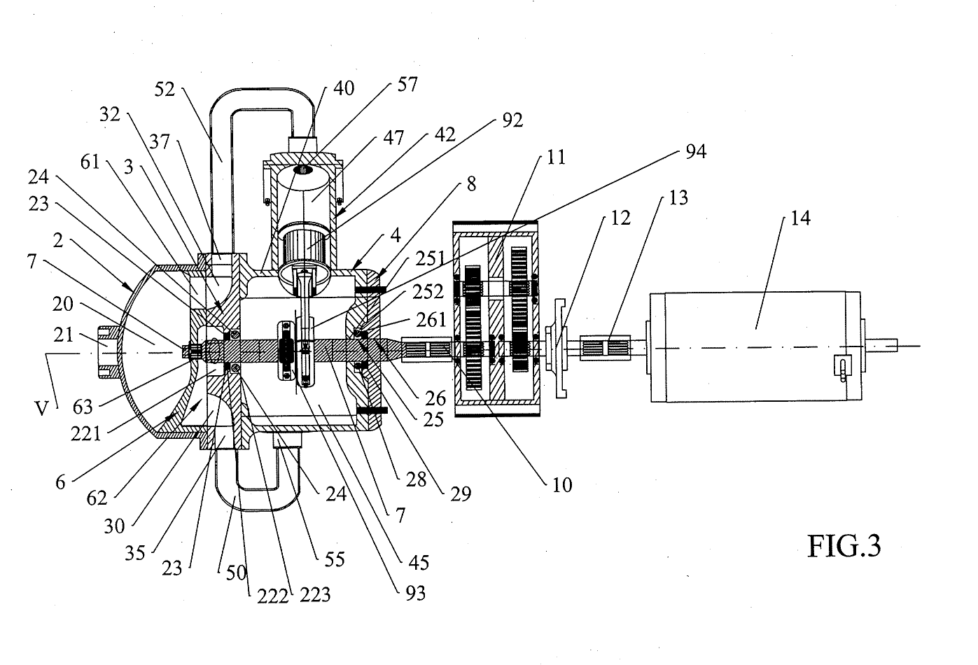

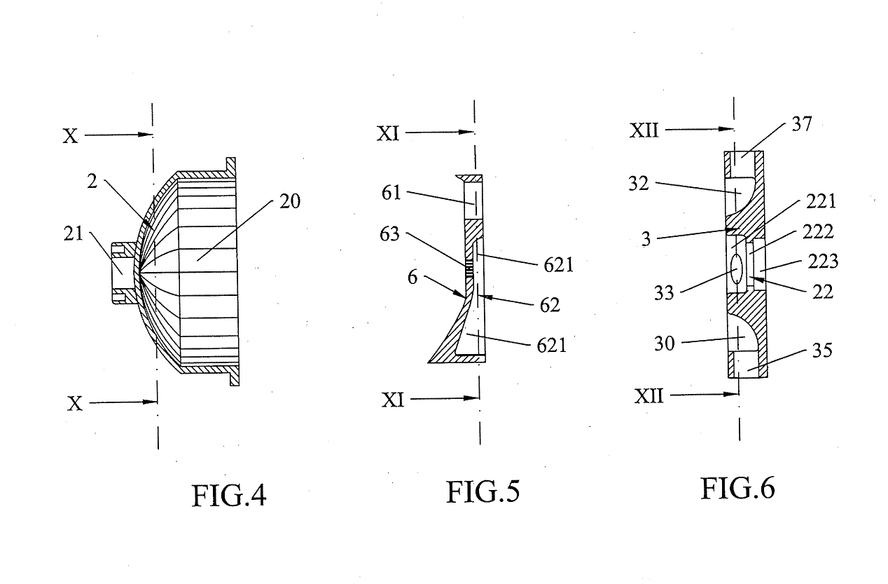

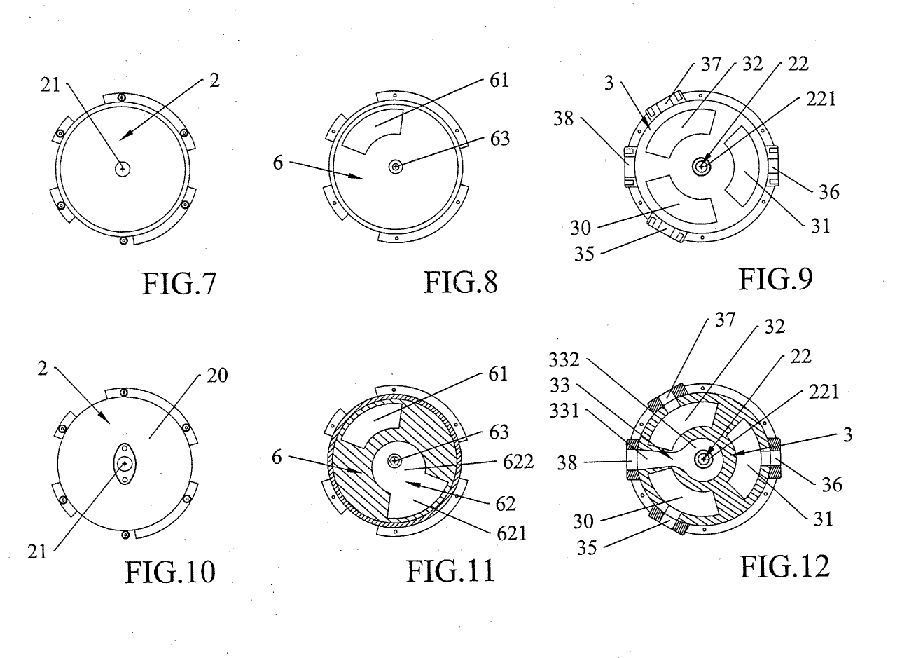

As shown in FIG. 3, a rotating slide valve 6, which is inside cover 2, is rotatably mounted on said distribution box 3.

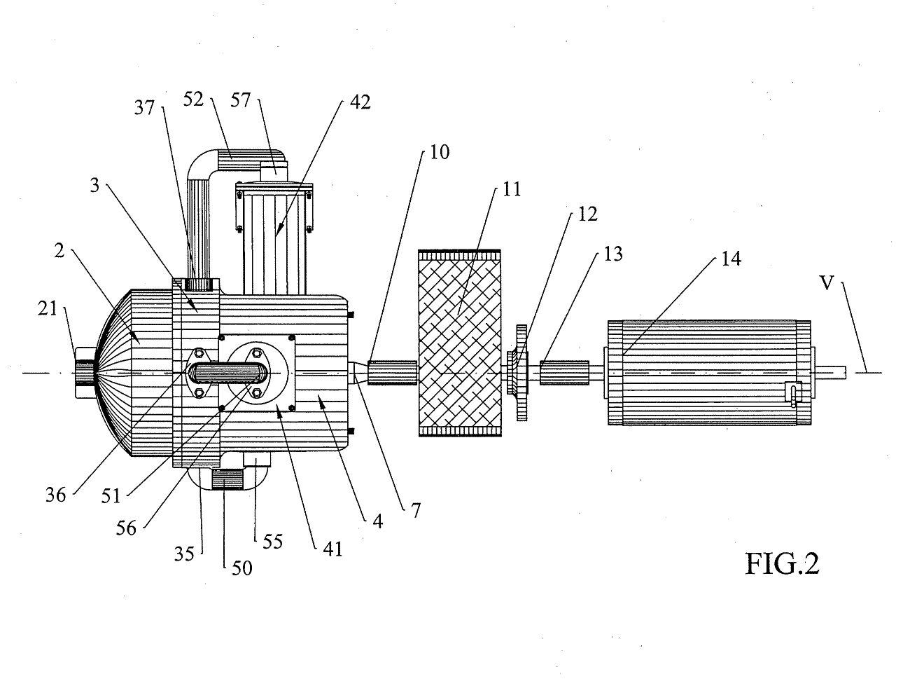

An inlet flange 21 for the water deriving from an aqueduct water supply (not shown in the figures) opens on the top of the dome of said cover 2. Said inlet flange 21 is crossed by an axis V which passes the whole hydraulic machine 1 from the front part to the rear part, as shown in particular in FIGS. 2 and 3.

As shown in FIG. 3, said cover 2 encloses a front chamber 20 on the distribution box 3, said front chamber 20 serving advantageously as basin collector for the water entering from said inlet flange 21.

As shown in FIG. 9, said distribution box 3 comprises three front cavities: a first cavity 30, a second cavity 31 and a third cavity 32 distributed radially around a through hole 22, through which axis V passes. A fourth cavity 33 is made inside the distribution box 3, as shown in FIG. 12.

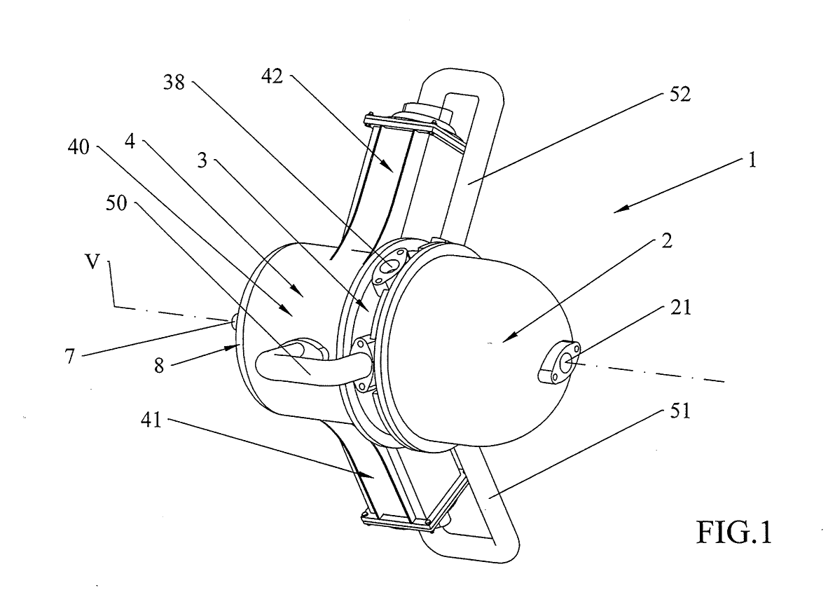

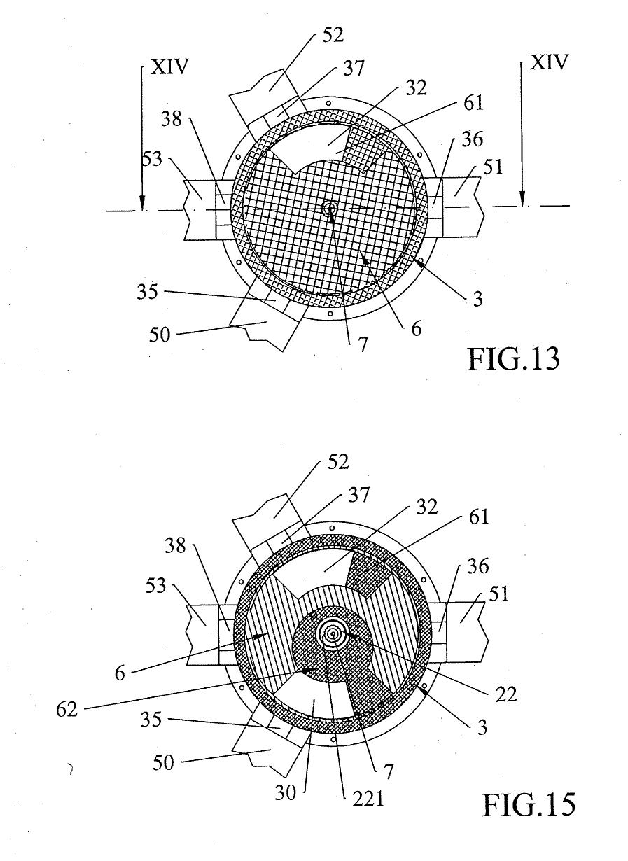

Four flanges respectively depart from each of said cavities 30-33: a first flange 35, a second flange 36, a third flange 37 and a fourth flange 38 in connection with respective four pipes, the first three of which are shown in FIG. 1: a first pipe 50, a second pipe 51 and a third pipe 52 connected with monoblock 4 and a fourth outlet pipe 53 (FIG. 13) which brings the water back to the water supply.

As shown in FIG. 9, the first cavity 30, the second cavity 31 and the third cavity 32 are arranged at 120° between them, instead the fourth cavity 33 is made inside said distribution box 3 in the section of cylinder between the first cavity 30 and the third cavity 32.

Said fourth cavity 33 is bulb-shaped with a first portion 331 of tubular neck-shaped, the first end of which is in connection with the fourth flange 38 and the second end is in connection with a second circular portion 332 in a bulb-bottom shape of the fourth cavity 33. The centre of said second portion 332 is at the centre in the through hole 22, as shown in FIG. 12.

Said through hole 22 of the distribution box 3 allows the passage of a crankshaft 7 along the axis V, as shown in FIG. 3.

Said through hole 22 is shaped according to three different radial thicknesses, as shown in FIG. 6: a front hole 221 with a greater radius than two other radial thicknesses: a median hole 222 and a rear hole 223. The front hole 221 is as large as the second portion 332 of the fourth cavity 33 so as to cause the water to flow therein. As shown in FIG. 3, the median hole 222 of the through hole 22 encloses a sealing sheath 23 between the through hole 22 and the crankshaft 7 so as not to allow the water to flow between the distribution box 3 and the monoblock 4. The rear hole 223 encloses bearings 24 to rotate the crankshaft 7.

As shown in FIG. 8, said rotating slide valve 6 comprises a through opening 61 having the same shape and dimensions as the cavities 30-32 of the distribution box 3, a rear hollow 62 (FIG. 11) and a connecting through hole 63.

Said through opening 61 is adapted to select a quantity of water which may flow in a given time range in one only of the respective openings 30, 31, 32 of the distribution box 3 while the rotating valve 6 rotates around axis V.

As shown in FIG. 11, said rear hollow 62 comprises two portions: a first sectional portion 621 with the same shape and dimensions as the cavities 30-32 of the distribution box 3 and a second circular-shaped central portion 622 of the same shape and dimensions as the second portion 332 of the fourth cavity 33 of the distribution box 3.

Said connecting through hole 63 allows crankshaft 7 to be mounted integrally with said rotating valve 6.

As shown in FIG. 3, said distribution box 3 is mounted on the central cylindrical body 40 of monoblock 4.

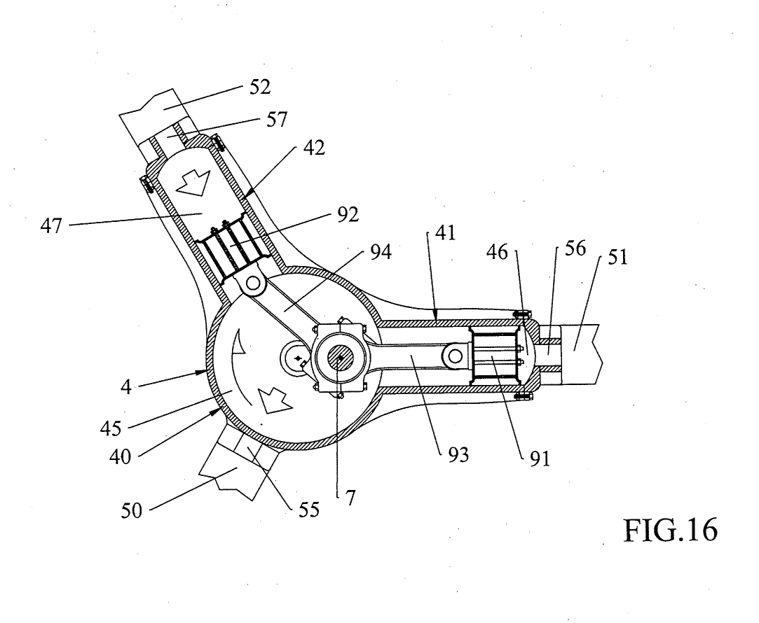

As shown in FIG. 16, said central cylindrical body 40 comprises a central chamber 45 connected to a first rear flange 55 in correspondence with the first flange 35 and said first rear flange 55 is connected to the first water pipe 50.

Said first arm 41 and said second arm 42 are respectively located in correspondence with the front flanges 36 and 37.

Said arms 41 and 42 comprise a first chamber 46 and a second chamber 47, respectively, which are connected to a second rear flange 56 and to a third rear flange 57, respectively. The second rear flange 56 is in turn connected to the second cavity 31 with the second pipe 51, instead the third rear flange 57 is in turn connected to the third cavity 32 of the distribution box 3 with the third pipe 52.

As shown in FIG. 3, said central cylindrical body 40 has a rear through hole 25 which allows the passage of crankshaft 7 along axis V.

Said rear through hole 25 is shaped according to two different radial thicknesses, as shown in FIG. 3: a first rear hole 251 and a second rear hole 252. The first rear hole 251 has the same dimensions as crankshaft 7, instead the second rear hole 252 is adapted to enclose bearings 28 which are adapted to cause said crankshaft 7 to rotate.

A rear cover 8 of the same dimensions as the central cylindrical body 40 closes the rear part of monoblock 4. Said rear cover 8 comprises one other rear through hole 26 which is shaped so as to allow the passage of crankshaft 7. Said other rear through hole 26 is shaped with a recess 261 which is adapted to contain a sealing sheath 29.

As shown in FIG. 16, said central chamber 45 is separate from the first chamber 46 and from the second chamber 47.

Sliding inside the first chamber 46 of the first arm 41 is a first piston 91 which is adapted to move in two forward and backward directions of the direction of the length of the first chamber 46. Said first piston 91 is connected to crankshaft 7 by means of a connecting rod 93.

Sliding inside the second chamber 47 of the second arm 42 is a second piston 92 which is adapted to move in two forward and backward directions of the direction of the length of the second chamber 47. Said second piston 92 is connected to crankshaft 7 by means of a connecting rod 94.

By rotating inside the through holes 22, 25 and 26, said crankshaft 7 is capable of moving the two pistons 91 and 92 forwards and backwards.

As shown in FIGS. 2 and 3, a portion of crankshaft 7 leaves the other rear through hole 26 and is adapted to be separately connected with a mandrel 10 to connect it to a revolution variator 11, as shown in FIG. 2. Said revolution variator 11 may be connected to an electric energy generator 14, for example, by means of a flywheel 12 and one other mandrel 13.

With regards to the operation of the hydraulic machine 1, we describe the path of the water while the hydraulic machine 1 is already full of water.

The water is emitted from the water supply into the inlet flange 21, as shown in FIG. 1. The water flows from inside the front chamber 20, which dome-shape advantageously slows down the speed of the water of the inlet pipe (not shown in the figures) of the water supply, thus contributing to avoiding destructive phenomena associated with overpressures such as for example, the phenomenon of the so-called water hammer.

The dome-shape of said front chamber 20 advantageously contributes to creating a basin for the water in the short time intervals in which by rotating on axis V, the through opening 61 does not match with any cavity 30-32, thus preventing the passage of the water.

As the through opening 61 rotates around axis V thus overtime revealing one only of the cavities 30-32 at a time in succession, substantially six different operating steps of the hydraulic machine 1 may be apparent.

Said six operating steps form a cycle of the hydraulic machine 1.

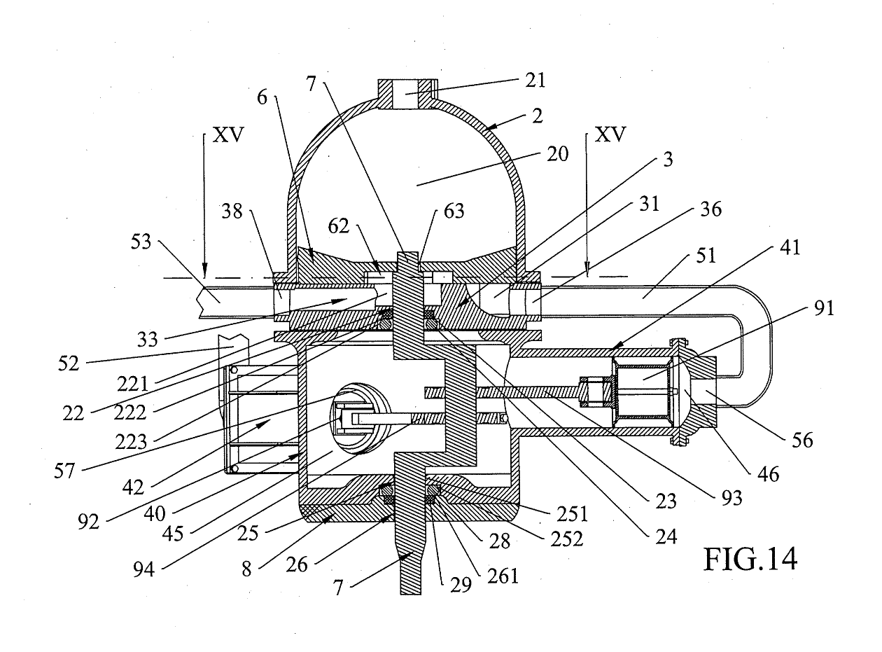

In the first operating step of the hydraulic machine I shown in FIGS. 13-16, it is apparent that the rotating slide valve 6 has the through opening 61 in correspondence with the third cavity 32 of the distribution box 3. Said first position of the through opening 61 allows the water inside the front chamber 20 to flow into the third cavity 32 of the distribution box 3.

The water flows through the third flange 37 of the distribution box 3 and travels through the third pipe 52 until it flows through the third rear flange 57 of the monoblock 4, as shown in FIG. 16, thus entering the second chamber 47 of the second arm 42 of monoblock 4 and pushing the second piston 92 towards the central chamber 45 of the monoblock 4.

The connecting rods 93 and 94 are moved by the action of the second piston 92 thus advantageously causing a rotary motion of crankshaft 7. At the same time, the motion of the two connecting rods 93 and 94 together with the motion of crankshaft 7 cause a rotary motion of the water in the central chamber 45 thus pushing it through the first rear flange 55 of the monoblock 4 in the first pipe 50 up to the first flange 35 of the distribution box 3, and to end up in the first cavity 30, as shown in FIG. 15.

The rear hollow 62 of the rotating slide valve 6 is positioned at the first cavity 30 and the fourth cavity 33 of the distribution box 3, as shown in FIG. 15.

The water enters the front hole 221 of the through hole 22 of the distribution box 3 by means of the rear hollow 62, as shown in FIG. 15. The water enters the fourth cavity 33 of the distribution box 3 and ends up in the outlet pipe 53 by means of the fourth flange 38, to be returned advantageously in pressure to the water supply.

The hydraulic machine 1 indeed uses only a part of the kinetic energy of the water from the water supply, thus allowing the water used to be advantageously re-emitted into the supply to produce electric energy with a partial loss of pressure.

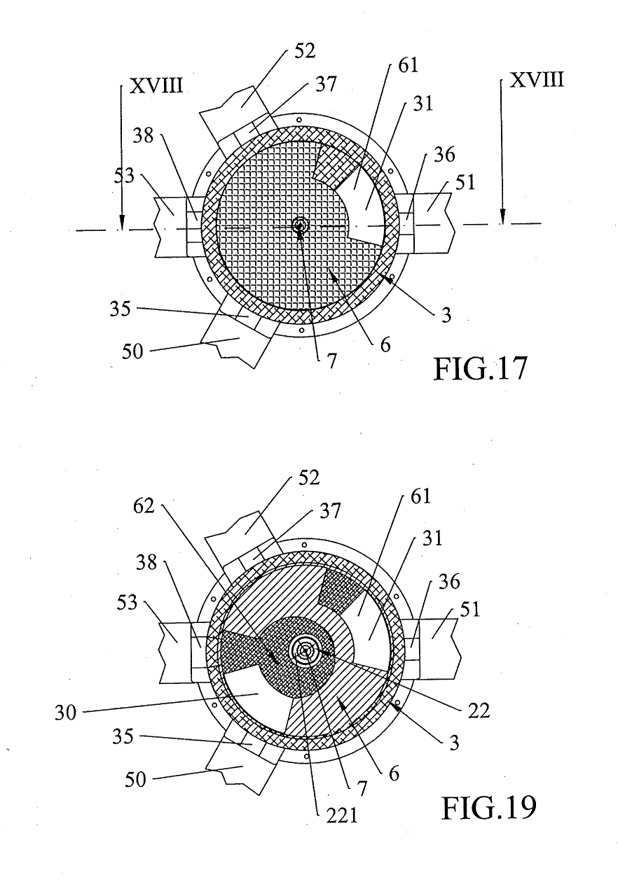

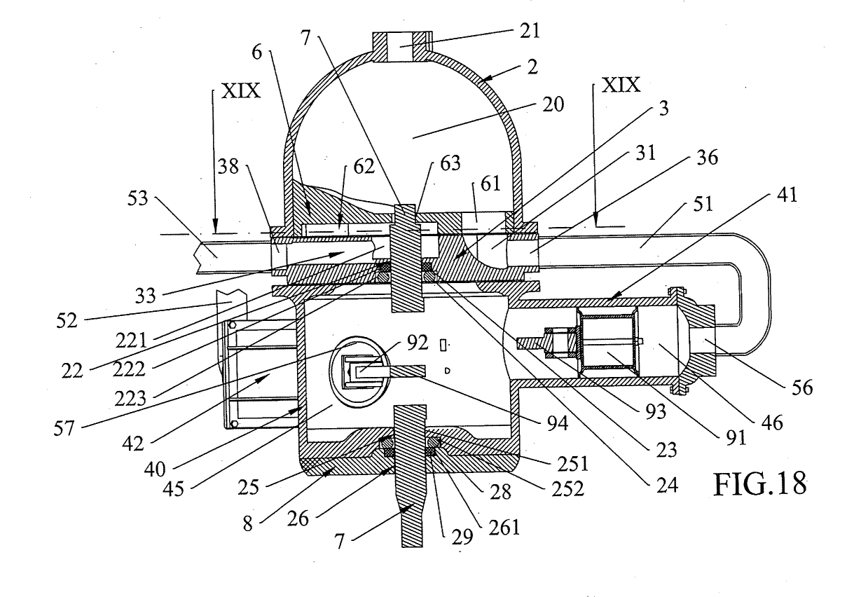

In the time interval after the description of the first operating step of the hydraulic machine 1, the rotating slide valve 6 is rotated around axis V due to the action of crankshaft 7, thus proceeding to the second operating step of the hydraulic machine 1, as shown in FIGS. 17-20.

In said second operating step of the hydraulic machine 1, it is apparent that the rotating slide valve 6 has the through opening 61 in correspondence with the second cavity 31 of the distribution box 3.

Said second position of the through opening 61 allows the water inside the front chamber 20 to flow into the second cavity 31.

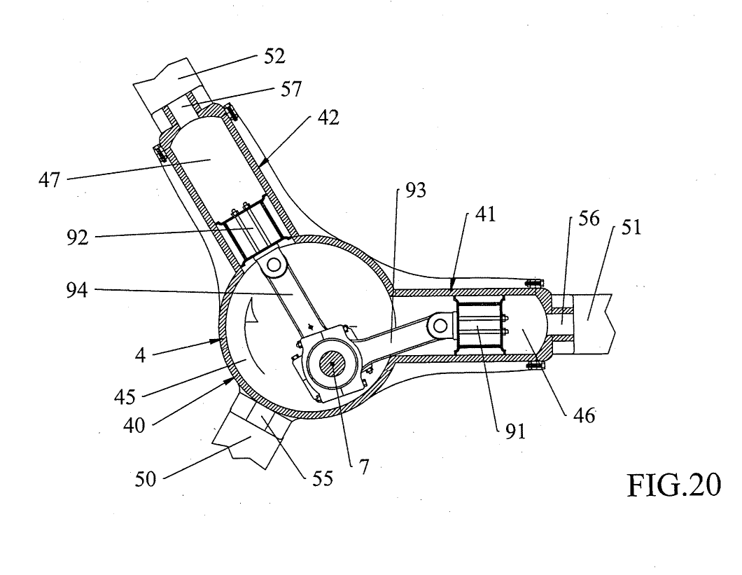

The water flows through the second flange 36 of the distribution box 3 and travels through the second pipe 51 until it flows through the second rear flange 56 of the monoblock 4 as shown in FIG. 20, thus entering the first chamber 46 of the first arm 41 of the monoblock 4. So the water pushes the first piston 91 towards the central chamber 45 of the monoblock 4.

Said first piston 91 pushes the first connecting rod 93 which in turn impresses a force on crankshaft 7 thus contributing to cause it to rotate inside the central chamber 45.

As crankshaft 7 rotates, it pushes the second connecting rod 94 which causes the second piston 92 to move towards the third pipe 52.

The water in the second chamber 47 of the second arm 42 of the monoblock 4 is then pushed towards the third rear flange 57 of the monoblock 4 thus starting to enter the third pipe 52.

At the same time, the motion of the two connecting rods 93 and 94 together with the motion of crankshaft 7 advantageously cause a rotary motion of the water in the central chamber 45 of the monoblock 4 thus pushing it through the first rear flange 55 of the monoblock 4 in the first pipe 50 up to the first flange 35 of the distribution box 3, and to end up in the first cavity 30, as shown in FIG. 19.

The rear hollow 62 of the rotating slide valve 6 is positioned at the first cavity 30 and at the fourth cavity 33 of the distribution box 3, as shown in FIG. 19.

The water enters the front hole 221 of the through hole 22 of the distribution box 3 through the rear hollow 62 of the rotating slide valve 6, as shown in FIG. 19. The water enters the fourth cavity 33 of the distribution box 3 and ends up in the outlet pipe 53 by means of the fourth flange 38, to be returned advantageously in pressure to the water supply.

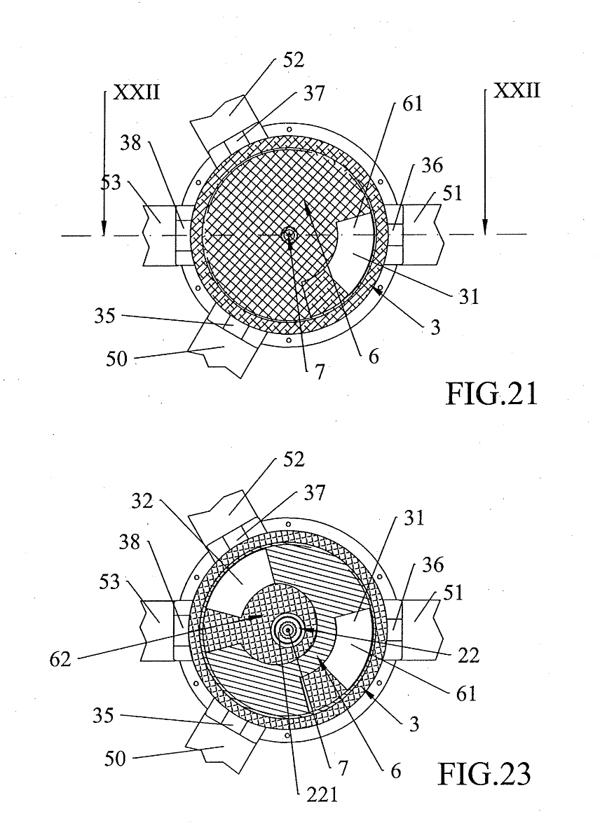

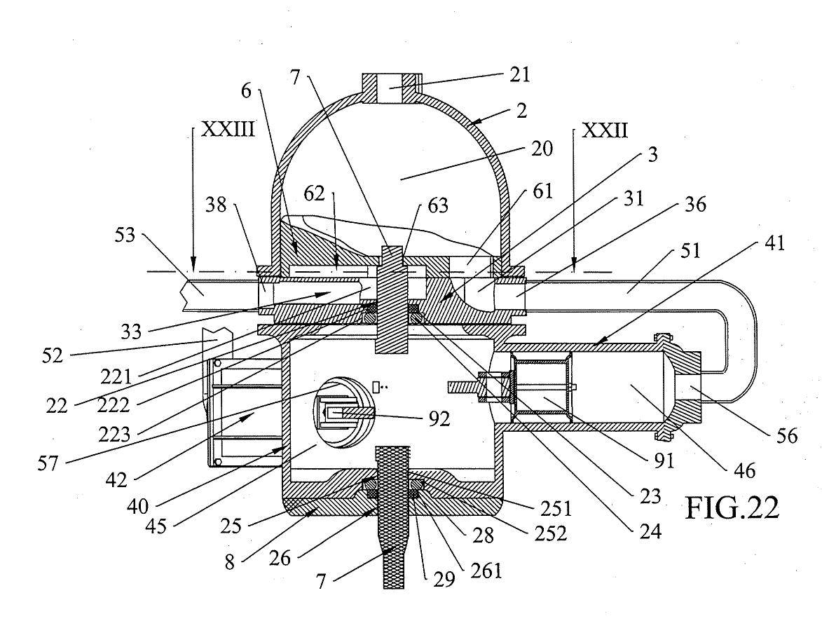

In the time interval after the description of the second operating step of the hydraulic machine 1, the rotating slide valve 6 is rotated around axis V due to the action of crankshaft 7, thus proceeding to the third operating step of the hydraulic machine 1, as shown in FIGS. 21-24.

In said third operating step of the hydraulic machine 1, it is apparent that the rotating slide valve 6 has the through opening 61 in correspondence with the second cavity 31 of the distribution box 3.

Said second position of the through opening 61 allows the water inside the front chamber 20 to flow into the second cavity 31 again of the distribution box 3, as in the second operating step.

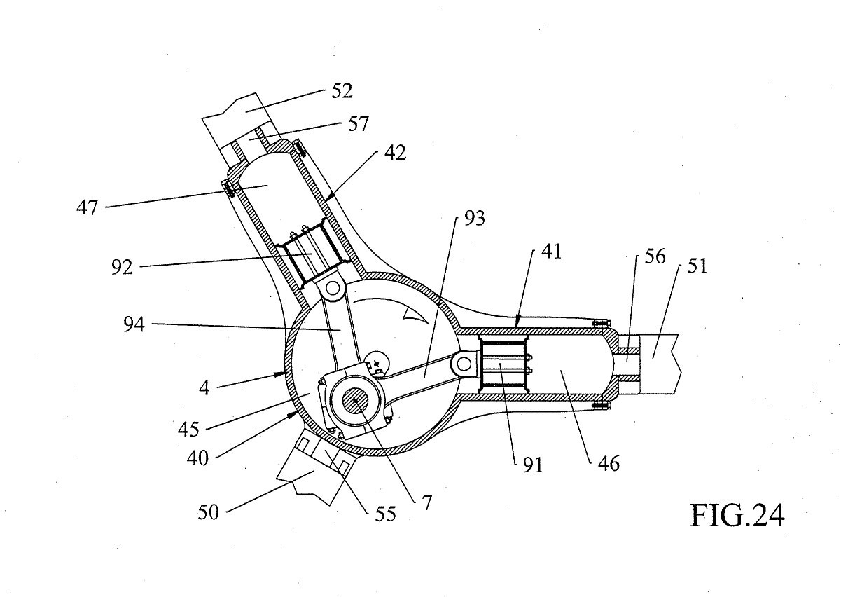

The water flows through the second flange 36 of the distribution box 3 and travels through the second pipe 51 until it flows through the second rear flange 56 of monoblock 4 as shown in FIG. 24, thus entering the first chamber 46 of the first arm 41 of monoblock 4 and filling it completely until the first piston 91 completes its travel towards the central chamber 45 of the monoblock 4.

Said first piston 91 continues pushing, to the end of its travel, the first connecting rod 93 which in turn impresses a force on crankshaft 7 thus contributing to causing it to rotate inside the central chamber 45.

As crankshaft 7 rotates, it continues pushing the second connecting rod which causes the second piston 92 to move towards the third pipe 52.

The water in the second chamber 47 of monoblock 4 is then pushed towards the third rear flange 57 of monoblock 4 thus continuing to enter the third pipe 52.

The water in said third pipe 52 flows through the third flange 37 of the distribution box 3, as shown in FIG. 23, and flows into the third cavity 32 of the distribution box 3.

As shown in FIG. 23, the rear hollow 62 of the rotating slide valve 6 is positioned at the third cavity 32 and at the fourth cavity 33 of the distribution box 3.

The water enters the front hole 221 of the through hole 22 of the distribution box 3 through the rear hollow 62 of the rotating slide valve 6, as shown in FIG. 23. The water enters the fourth cavity 33 and ends up in the outlet pipe 53 by means of the fourth flange 38 of the distribution box 3, to be returned advantageously in pressure to the water supply.

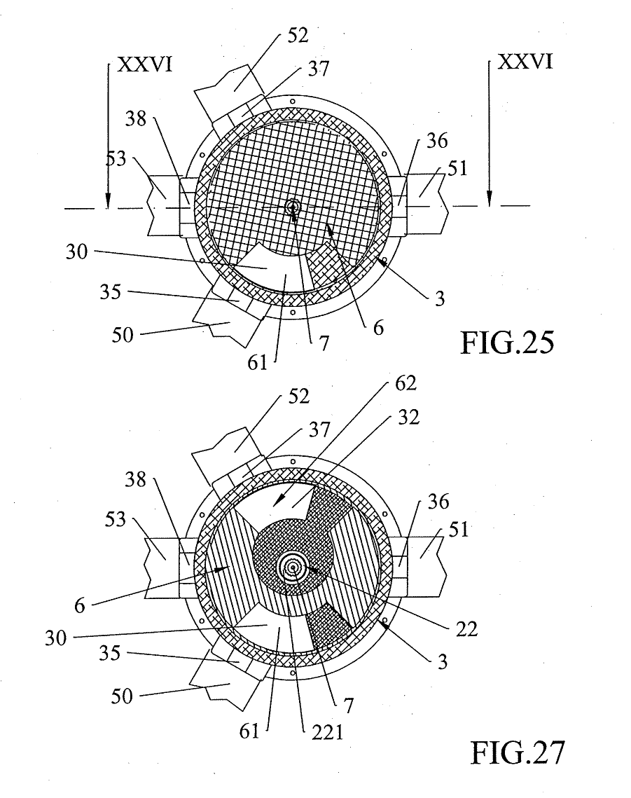

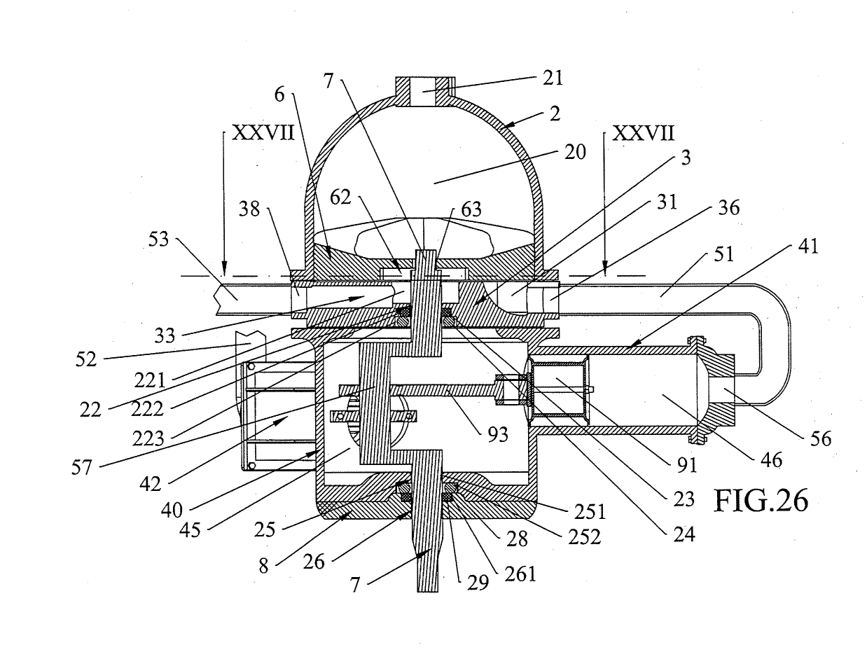

In the time interval after the description of the third operating step of the hydraulic machine 1, the rotating slide valve 6 is rotated around axis V due to the action of crankshaft 7, thus proceeding to the fourth operating step of the hydraulic machine 1, as shown in FIGS. 25-28.

In said fourth operating step of the hydraulic machine 1, it is apparent that the rotating slide valve 6 has the through opening 61 at the first cavity 30 of the distribution box 3. Said fourth position of the through opening 61 allows the water inside the front chamber 20 to flow into the first cavity 30 of the distribution box 3.

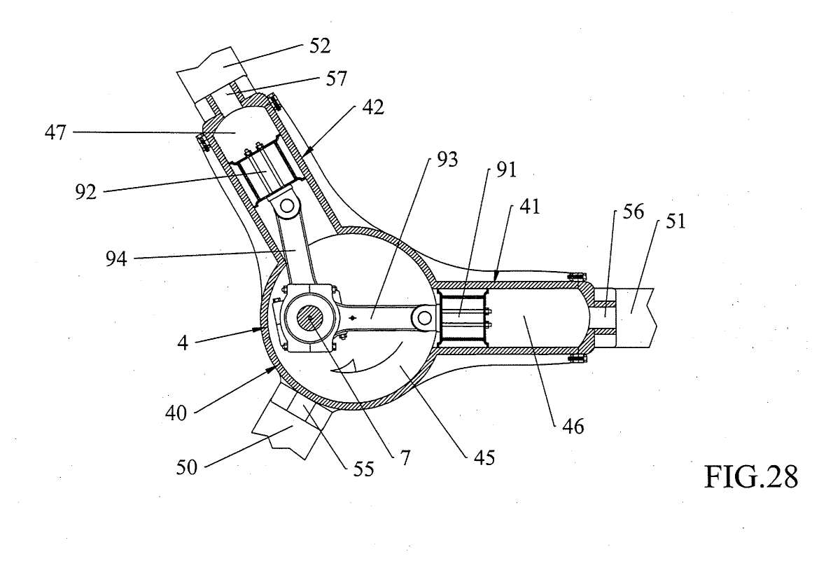

The water flows through the first flange 35 of the distribution box 3 and travels through the first pipe 50 of the monoblock 4 until it flows through the first rear flange 55 of monoblock 4, as shown in FIG. 28.

The water enters the central chamber 40 of monoblock 4 from the first pipe 50 and contributes advantageously to impressing a rotary motion on crankshaft 7 which moves the two connecting rods 93 and 94, as shown in FIG. 28.

Advantageously, no third piston is installed on said hydraulic machine 1, given that the rotary motion of the water combined sinergistically with the force of inertia of crankshaft 7, which was already rotating as described in the preceding first, second and third operating steps, continue pushing the second connecting rod 94, as though they were carrying out the functions of a third piston. Said second connecting rod 94 in turn pushes the second piston 92 towards the third pipe 52 as in the third operating step of the hydraulic machine 1.

The water in the second chamber 47 of the second arm 42 of the monoblock 4 continues to flow towards the third pipe 52.

At the same time, the rotary motion of the water combined sinergistically with the force of inertia of crankshaft 7, which up to said third operating step of the hydraulic machine 1 were dragging the first connecting rod 93, begin pushing the first connecting rod 93, as though they were carrying out the functions of a third piston, so as to invert the motion of the first piston 91 towards the second pipe 51, which said first piston 91 arrived at the stop during the third operating step of the hydraulic machine 1.

Said first piston 91 starts pushing the water which filled the first chamber 46 of the monoblock 4, towards the second pipe 51.

The water in the first chamber 46 is then pushed towards the second rear flange 56 of the monoblock 4 thus continuing to enter the second pipe 51.

The water in said second pipe 51 flows through the second flange 36 of the distribution box 3, as shown in FIG. 27, and flows into the second cavity 31 of the distribution box 3.

As shown in FIG. 27, the rear hollow 62 of the rotating slide valve 6 is positioned in correspondence with the second cavity 31 and at the fourth cavity 33 of the distribution box 3.

The water enters the front hole 221 of the through hole 22 through the rear hollow 62 of the rotating slide valve 6, as shown in FIG. 27. The water enters the fourth cavity 33 of the distribution box 3 and ends up in the outlet pipe 53 by means of the fourth flange 38 of the distribution box 3, to be returned advantageously in pressure to the water supply.

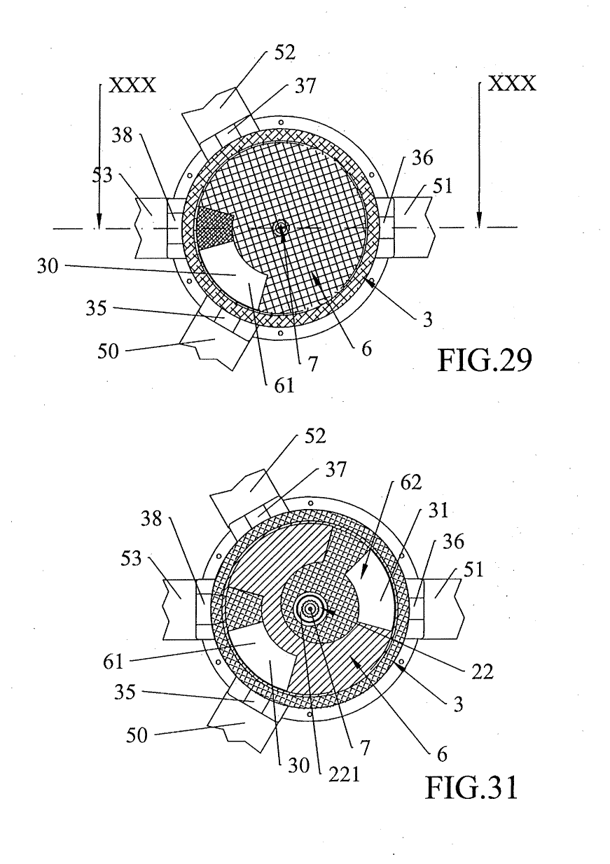

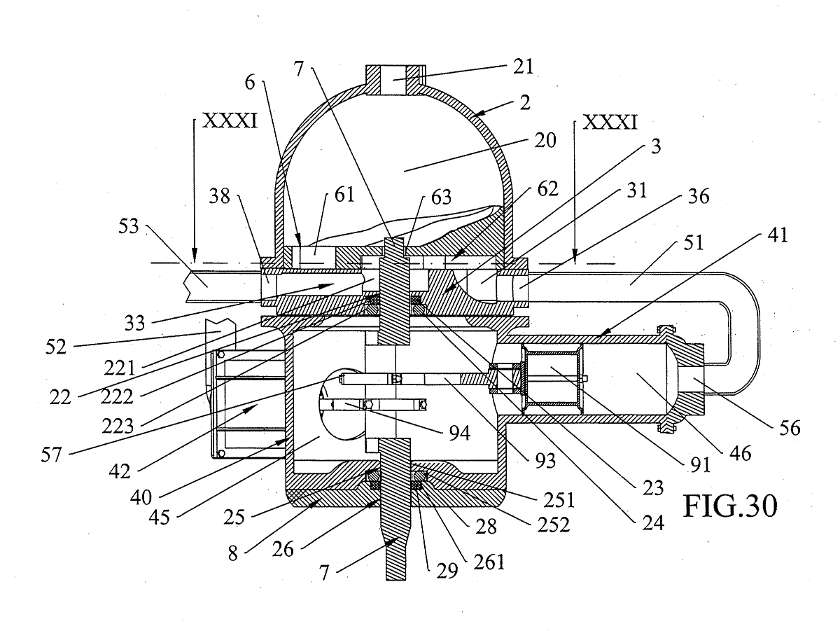

In the time interval after the description of the fourth operating step of the hydraulic machine 1, the rotating slide valve 6 is rotated around axis V due to the action of crankshaft 7, thus proceeding to the fifth operating step of the hydraulic machine 1, as shown in FIGS. 29-32.

In said fifth operating step of the hydraulic machine 1, it is apparent that the rotating slide valve 6 has the through opening 61 in correspondence with the first cavity 30 of the distribution box 3, similarly to said fourth operating step.

Said fifth position of the through opening 61 allows the water inside the front chamber 20 to flow into the first cavity 30 again, as in said fourth operating step.

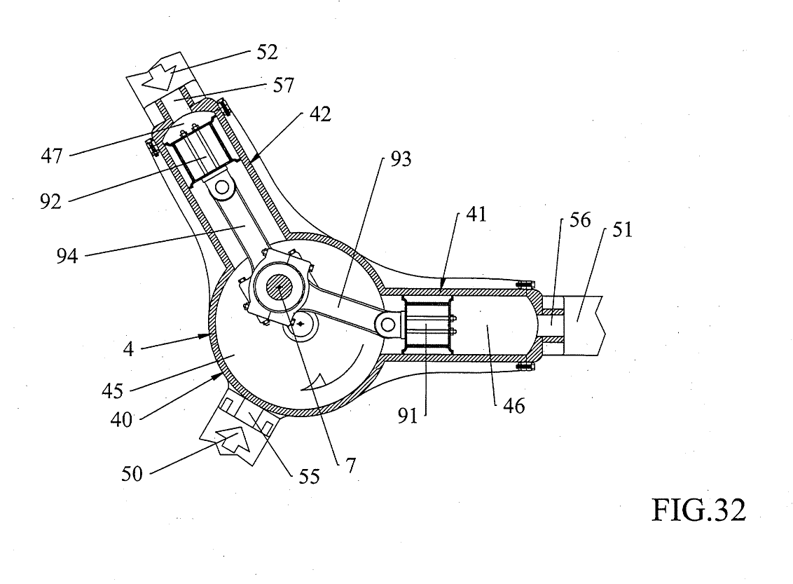

The water flows through the first flange 35 of the distribution box 3 and travels through the first pipe 50 until it flows through the first rear flange 55 of the monoblock 4, as shown in FIG. 32, thus entering the central chamber 40 of the monoblock 4.

Similarly to the fourth operating step of the hydraulic machine 1, the water continues entering the central chamber 40 of the monoblock 4 from the first pipe 50, thus contributing advantageously to impress a rotary motion on crankshaft 7 which moves the two connecting rods 93 and 94, as shown in FIG. 32.

The rotary motion of the water combined sinergistically with the force of inertia of crankshaft 7, which was already rotating as described in the preceding first, second, third and fourth operating steps, continues to push the second connecting rod 94, which in turn pushes the second piston 92 towards the third pipe 52 up to stop.

The water flows completely from the second chamber 47 of the second arm 42 of the monoblock 4 towards the third pipe 52.

At the same time, the rotary motion of the water combined sinergistically with the force of inertia of crankshaft 7 continues to push the first connecting rod 93, as in the fourth operating step of the hydraulic machine 1. Said first connecting rod 93 continues pushing the first piston 91 towards the second pipe 51 thus pushing the water therein, through the second rear flange 56 of the monoblock 4.

The water in said second pipe 51 flows through the second flange 36 of the distribution box 3, as shown in FIG. 31, and flows into the second cavity 31 of the distribution box 3.

As shown in FIG. 31, the rear hollow 62 of the rotating slide valve 6 is positioned in correspondence with the second cavity 31 and in correspondence with the fourth cavity 33 of the distribution box 3.

The water enters the front hole 221 of the through hole 22 of the distribution box 3, through the rear hollow 62 of the rotating slide valve 6. as shown in FIG. 31. The water enters the fourth cavity 33 of the distribution box 3 and ends up in the outlet pipe 53 by means of the fourth flange 38, to be returned advantageously in pressure to the water supply.

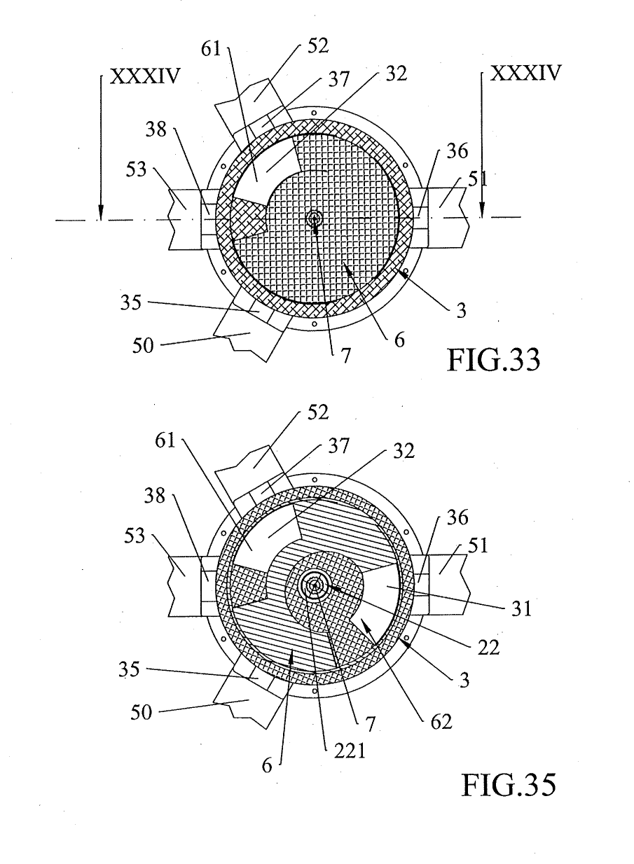

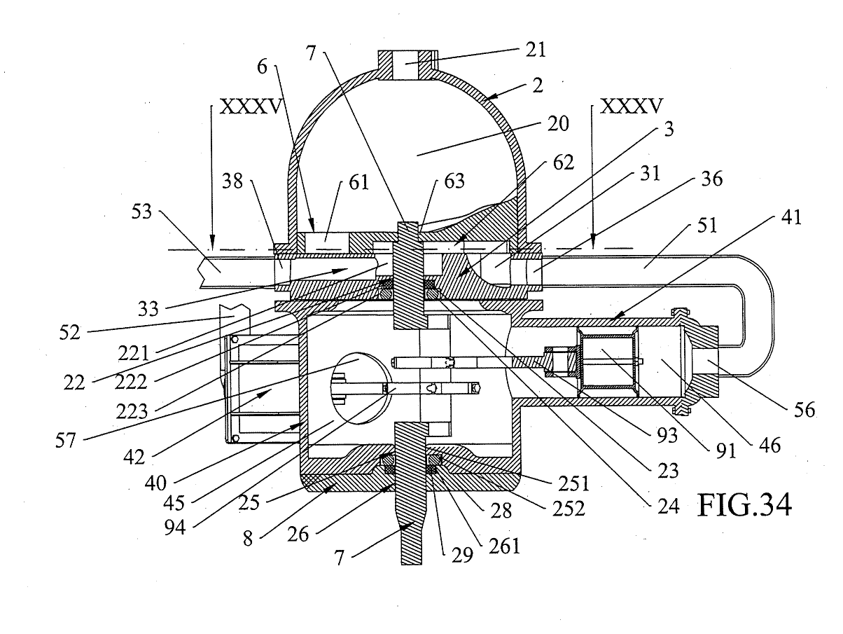

In the time interval after the description of the fifth operating step of the hydraulic machine 1, the rotating slide valve 6 is rotated around axis V due to the action of crankshaft 7, thus proceeding to the sixth operating step of the hydraulic machine 1, as shown in FIGS. 33-36.

In said sixth operating step of the hydraulic machine 1, it is apparent that the rotating slide valve 6 has the through opening 61 in correspondence with the third cavity 32 of the distribution box 3, as in said first operating step of the hydraulic machine 1.

Said sixth position of the through opening 61 allows the water inside the front chamber 20 to flow again into the third cavity 32 of the distribution box 3.

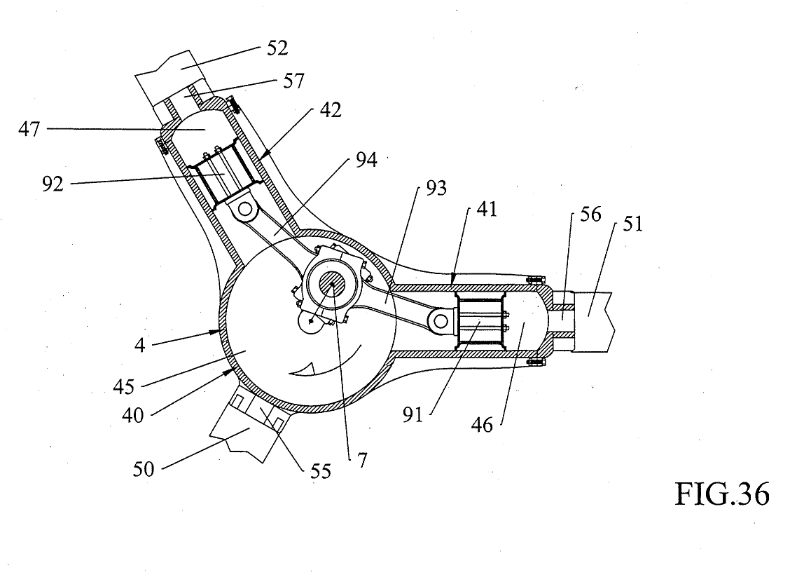

The water flows through the third flange 37 of the distribution box 3 and travels through the third pipe 52 until it flows through the third rear flange 57 of the monoblock 4, as shown in FIG. 36, thus entering the second chamber 47 and pushing the second piston 92 towards the central chamber 45 of the monoblock 4.

Said second piston 92 pushes the second connecting rod 94 which in turn impresses a force on crankshaft 7 thus contributing to cause it to rotate inside the central chamber 45.

As crankshaft 7 rotates, it pushes the first connecting rod 93 which continues causing the first piston 91 to move towards the second pipe 51, as in said preceding fifth operating step of the hydraulic machine.

The water in the first chamber 46 of the first arm 41 of monoblock 4 is then pushed towards the second rear flange 56 of monoblock 4 thus entering the second pipe 51.

At the same time, the motion of the two connecting rods 93 and 94 together with the motion of crankshaft 7 advantageously sinergistically cause a rotary motion of the water in the central chamber 45 thus pushing it to remain in the first pipe 50, as shown in FIG. 36.

As shown in FIG. 35, the rear hollow 62 is positioned at the second cavity 31 of the distribution box 3, from which the water is entering from the second pipe 51, and with the fourth cavity 33 of the distribution box 3.

The water enters in the front hole 221 of the through hole 22 of the distribution box 3 by means of the rear hollow 62 of the rotating slide valve 6, as shown in FIG. 19. The water enters the fourth cavity 33 and ends up in the outlet pipe 53 by means of the fourth flange 38 of the distribution box 3, to be returned advantageously in pressure to the water supply.

In the time interval after the description of the sixth operating step of the hydraulic machine 1, the rotating slide valve 6 is rotated around axis V due to the action of crankshaft 7, thus proceeding again to the first operating step already described above and advantageously resuming the cycle of said hydraulic machine 1.

The dimensions of the front chamber 20, of the cavities 30-33, of the rear hollow 62, of the chambers 45-47 and of the pipes 50-52 are calibrated to cause the hydraulic machine 1 to operate in synchrony and obtain the rotation of crankshaft 7 in order to convert the kinetic energy of the water in pressure of the water supply into mechanical energy which is useful for rotating mandrel 10 rotatably connected with the revolution variator 11, as shown in FIG. 2, and for rotating the other mandrel 13 to transmit the motion to the electric energy generator 14.

Said revolution variator 11 advantageously allows the efficiency of the hydraulic machine 1 to be further increased according to the flow rate and pressure of the water supply.

Alternatively, mechanical energy may be extracted instead of electric energy, thus replacing the electric energy generator 14 with another device for performing mechanical operations.

A further alternative allows the hydraulic machine I to be connected directly to an electric energy generator 14 or to another device adapted to perform mechanical operations.

A further alternative again consists of increasing the dimensions of the hydraulic machine 1 thus increasing the number of pairs of pistons 91-92 in monoblock 4. According to said alternative, in order to operate synchronously, the hydraulic machine 1 also increases, according to the number of pairs of pistons 91-92: the number of cavities 30-33 of the distribution box 3; the number of pipes 50-52 between the distribution box 3 and the monoblock 4 and the number of openings 61 and of the rear hollows 62 of the rotating slide valve 6. Again in said alternative, a cover 2 with a larger front chamber 20 may be envisaged.

Advantageously, the hydraulic machine 1 according to the present invention exploits a part of the kinetic energy of the water in pressure flowing in the water supply thus allowing electric energy to be generated efficiently.

One other advantage consists of the fact that once the water has passed inside the hydraulic machine 1, it undergoes moderate and controllable pressure losses, and may therefore be re-emitted into the water supply.

One other advantage again of the present invention is the fact that said hydraulic machine 1 allows electric energy to be produced within a wide range of pressure and flow rate values of the water supply, thus advantageously allowing said hydraulic machine 1 to also be used in the presence of water flows with relatively low flow rate or pressure.

A further advantage consists of the fact that the hydraulic machine 1 may also be used to regulate the pressure of the water supply by using the excess power to generate electric energy. Said hydraulic machine 1 may therefore replace dissipation tanks already present on the water supply.

A further advantage again consists of the fact that said hydraulic machine 1 may also operate in the presence of significant or sudden overpressures due to the dome-shape of the front chamber 20 of cover 2.

An advantage again consists of the fact that said hydraulic machine 1 is solid and long-lasting with parts subject to little wear over time.

A further advantage consists of the fact that said hydraulic machine I operates with the two pistons 91 and 92 alone, given that the rotary motion of the water in the central chamber 45 of the monoblock 4 and the inlet of the water from the first pipe 50 to the central chamber 45, combined sinergistically with the force of inertia of crankshaft 7 and of the connecting rods 93 and 94, perform the functions of a third piston.

Again, a further advantage of the present invention is that the hydraulic machine 1 may operate both in line with the water supply according to axis V, or in vertical with respect to the ground.

1. Volumetric hydraulic machine for water supply in pressure, wherein it comprises a rotating slide valve integral with a crankshaft which rotates around an axis, said rotating slide valve is rotatably mounted on a distribution box that includes a plurality of cavities respectively connected to a plurality of pipes of which an outlet pipe connected with the output in the water supply, the other remaining pipes of said plurality of pipes each respectively connected with only one of a plurality of chambers of a monoblock which integrally mounts said distribution box, said monoblock comprising a central chamber and at least a pair of further chambers, the interior of said central chamber being suitable for allowing the rotation of the water set in motion by said crankshaft, engaging at least a pair of connecting rods, each of said connecting rods mounting a piston each of which said pistons changes the volume of one of said pair of further chambers.

2. The hydraulic machine according to claim 1, wherein said distribution box comprises at least three cavities arranged at regular intervals between them according to a central symmetry with respect to the axis and at least a fourth cavity comprising a front hole.

3. The hydraulic machine according to claim 2, wherein said fourth cavity comprises at least a first portion being tubular and being in connection with said outlet pipe into the water supply and a second portion being of circular shape through which passes said axis and said second portion comprises said front hole.

4. The hydraulic machine according to claim 1, wherein said rotating slide valve comprises at least a through opening suitable to select one of said at least three cavities and a rear hollow into communication with said fourth cavity and said rear hollow suitable to select at least one of the remaining of said at least three cavities.

5. The hydraulic machine according to claim 1, wherein said monoblock comprises a central cylindrical body which locates in its interior said central chamber comprising a first rear flange into connection with said first pipe and said monoblock comprising at least a pair of arms, each of said arms respectively comprises a chamber of said pair of further chambers, said further chambers connected respectively to a second pipe and a third pipe arranged in said central symmetry with respect to the axis of said at least three cavities of said distribution box.

6. The hydraulic machine according to claim 1, wherein a cover of dome-shape is integrally connected to said distribution box enclosing a front chamber connected to said rotating slide valve, on the top of the dome of said cover is opened an inlet flange for the water of the water supply.

7. The hydraulic machine according to claim 1, wherein said crankshaft is integrally connected to said rotating slide valve through a connecting through hole and said crankshaft is rotatably connected to said distribution box through a through hole which comprises said front hole and said crankshaft is rotatably connected with said monoblock through a rear through hole.

8. The hydraulic machine according to claim 1, wherein said crankshaft is separably connected along said axis with a generator of electric current or with another equipment to perform mechanical operations.
